(19) United States
(12) Patent Application Publication
(10) Pub. No.: US 2022/0408472 A1
(43) Pub. Date: Dec. 22, 2022

(54) TERMINAL AND RADIO COMMUNICATION METHOD

(71) Applicant: NTT DOCOMO, INC., Tokyo (JP)

(72) Inventors: Yuki Matsumura, Tokyo (JP); Satoshi Nagata, Tokyo (JP); Shaozhen Guo, Beijing (CN)

(73) Assignee: NTT DOCOMO, INC., Tokyo (JP)

(21) Appl. No.: 17/776,464

(22) PCT Filed: Nov. 15, 2019
(86) PCT No.: PCT/JP2019/044973

§ 371 Date: May 12, 2022

(51) Int. Cl. H04W 72/12; H04W 28/06

(52) U.S. Cl. CPC H04W 72/1289; H04W 28/06

(57) ABSTRACT

One aspect of a terminal of the present disclosure includes a receiving section that receives downlink control information including a time domain resource allocation (TDRA) field, and a control section determines a size of the TDRA field, based on information notified by higher layer signaling.

### TECHNICAL FIELD

The present disclosure relates to a terminal and a radio communication method in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (e.g., referred to as “5th generation mobile communication system (5G),” “5G+ (plus),” “New Radio (NR),” “3GPP Rel. 15 (or later versions),” and so on) are also under study.

In existing LTE systems (for example, 3GPP Rel. 8 to Rel. 14), a user terminal (UE (User Equipment)) controls reception of a downlink shared channel (for example, a PDSCH (Physical Downlink Shared Channel)), based on downlink control information (also referred to as DCI, DL assignment, or the like) from a base station. The user terminal controls transmission of an uplink shared channel (for example, a PUSCH (Physical Uplink Shared Channel)), based on DCI (also referred to as an UL grant).

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (hereinafter referred to as NR), performing scheduling of a shared channel or the like using downlink control information (DCI) is under study. For example, the UE determines resource allocation of a shared channel in the time domain, based on information related to time domain resource allocation included in the DCI.

In existing radio communication systems (for example, Rel. 15), a certain number of time domain resource allocation candidates are configured from the base station to the UE, and the UE determines allocation of the shared channel, based on information notified by the DCI. Meanwhile, in the future radio communication systems, changing (for example, increasing) of the number of time domain resource allocation candidates configured for the UE is also assumed.

However, in such a case, how to control configuration of the time domain resource allocation candidates, reception processing of the DCI specifying a specific candidate, or the like poses a problem.

In view of this, the present disclosure has an object to provide a terminal and a radio communication method that enable appropriate determination of allocation of a shared channel even when the number of time domain resource allocation candidates configured for the UE is changed.

### Solution to Problem

A terminal according to one aspect of the present disclosure includes: a receiving section that receives downlink control information including a time domain resource allocation (TDRA) field; and a control section determines a size of the TDRA field, based on information notified by higher layer signaling.

### Advantageous Effects of Invention

According to one aspect of the present disclosure, communication can be appropriately performed even when transmission of downlink control information and a shared channel is flexibly configured.

### BRIEF DESCRIPTION OF DRAWINGS

FIG. 1A to FIG. 1D are each a diagram to show an example of a multi-TRP scenario;

FIG. 2 is a diagram to show an example of a table (TDRA table) in which time domain resource allocation information is configured;

FIG. 3A and FIG. 3B are each a diagram to show an example of allocation control of a PDSCH;

FIG. 4 is a diagram to show an example of the TDRA table in which a repetition factor is configured;

FIG. 5 is a diagram to show an example of a schematic structure of a radio communication system according to one embodiment;

FIG. 6 is a diagram to show an example of a structure of a base station according to one embodiment;

FIG. 7 is a diagram to show an example of a structure of a user terminal according to one embodiment; and

FIG. 8 is a diagram to show an example of a hardware structure of the base station and the user terminal according to one embodiment.

### DESCRIPTION OF EMBODIMENTS

### Services (Traffic Types)

In future radio communication systems (for example, NR), traffic types (also referred to as types, services, service types, communication types, use cases, or the like), such as further enhancement of mobile broadband (for example, enhanced Mobile Broadband (eMBB)), machine type communication that implements multiple simultaneous connection (for example, massive Machine Type Communications (mMTC), Internet of Things (IoT)), and high-reliable and low-latency communication (for example, Ultra-Reliable and Low-Latency Communications (URLLC)), are assumed. For example, in URLLC, lower latency and higher reliability in comparison to eMBB are required.

The traffic type may be identified based on at least one of the following in a physical layer.

Logical channel having different priority
Modulation and coding scheme (MCS) table (MCS index table)
Channel quality indication (CQI) table
DCI format
(Radio network temporary indicator (RNTI (System Information-Radio Network Temporary Identifier))) used for scrambling (masking) of cyclic redundancy check (CRC) bits included in (added to) the DCI (DCI format)
RRC (Radio Resource Control) parameter
Specific RNTI (for example, an RNTI for URLLC, an MCS-C-RNTI, or the like)
Search space
Certain field in DCI (for example, a newly added field or reuse of an existing field)

The traffic type may be associated with communication requirements (requirements such as latency and an error rate, a required condition), a data type (such as voice and data), and the like.

The difference between requirements of URLLC and requirements of eMBB may be that latency of URLLC is lower than latency of eMBB, or may be that the requirements of URLLC include requirements of reliability.

### Multi-TRPs

In NR, a scheme in which one or a plurality of transmission/reception points (TRPs) (multi-TRPs) perform DL transmission to the UE by using one or a plurality of panels (multi-panels) has been under study. A scheme in which the UE performs UL transmission to one or a plurality of TRPs has been under study.

Note that the plurality of TRPs may correspond to the same cell identifier (ID), or may correspond to different cell IDs. The cell ID may be a physical cell ID, or may be a virtual cell ID.

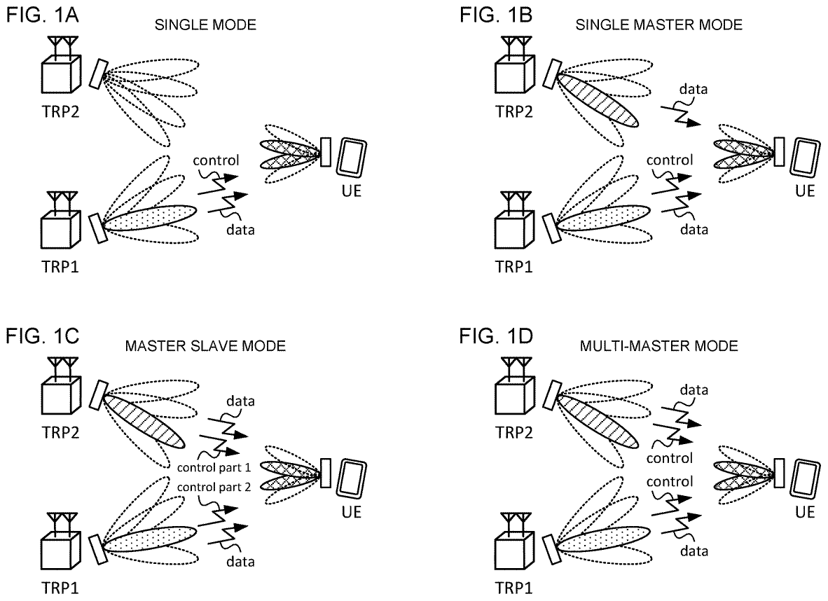

FIGS. 1A to 1D are each a diagram to show an example of a multi-TRP scenario. In these examples, it is assumed that each TRP can transmit four different beams. However, this is not restrictive.

FIG. 1A shows an example of a case (which may be referred to as a single mode, a single TRP, or the like) in which only one TRP (in the present example, TRP 1) out of the multi-TRPs performs transmission to the UE. In this case, TRP 1 transmits both of a control signal (PDCCH) and a data signal (PDSCH) to the UE.

FIG. 1B shows an example of a case (which may be referred to as a single master mode) in which only one TRP (in the present example, TRP 1) out of the multi-TRPs transmits a control signal to the UE, and the multi-TRPs transmit a data signal thereto. The UE receives each PDSCH transmitted from the multi-TRPs, based on one piece of downlink control information (DCI).

FIG. 1C shows an example of a case (which may be referred to as a master slave mode) in which each of the multi-TRPs transmits a part of a control signal to the UE, and the multi-TRPs transmit a data signal thereto. In TRP 1, part 1 of a control signal (DCI) may be transmitted, and in TRP 2, part 2 of the control signal (DCI) may be transmitted. Part 2 of the control signal may depend on part 1. The UE receives each PDSCH transmitted from the multi-TRPs, based on these parts of the DCI.

FIG. 1D shows an example of a case (which may be referred to as a multi-master mode) in which each of the multi-TRPs transmits different control signals to the UE, and the multi-TRPs transmit a data signal thereto. In TRP 1, a first control signal (DCI) may be transmitted, and in TRP 2, a second control signal (DCI) may be transmitted. The UE receives respective PDSCHs transmitted from the multi-TRPs, based on these pieces of DCI.

When a plurality of PDSCHs (which may be referred to as multi-PDSCHs (multiple PDSCHs)) from the multi-TRPs as shown in FIG. 1B are scheduled using one piece of DCI, the piece of DCI may be referred to as a single DCI (single PDCCH). When a plurality of PDSCHs from the multi-TRPs as shown in FIG. 1D are scheduled using a plurality of pieces of DCI, the plurality of pieces of DCI may be referred to as multi-DCIs (multi-PDSCHs (multiple PDSCHs)).

From each TRP of the multi-TRPs, codewords (Code Words (CWs)) and layers different from one another may be transmitted. As one mode of multi-TRP transmission, non-coherent joint transmission (NCJT) has been under study.

In NCJT, for example, TRP 1 performs modulation mapping on a first codeword and then performs layer mapping so as to transmit a first PDSCH by using a first number of layers (for example, two layers) by means of first precoding. TRP 2 performs modulation mapping on a second codeword and then performs layer mapping so as to transmit a second PDSCH by using a second number of layers (for example, two layers) by means of second precoding.

Note that it may be defined that a plurality of PDSCHs (multi-PDSCHs) to be transmitted using NCJT partially or entirely overlap regarding at least of the time and frequency domains. In other words, at least one of the time and frequency resources of the first PDSCH from the first TRP and the second PDSCH from the second TRP may overlap.

It may be assumed that the first PDSCH and the second PDSCH are not in a quasi-co-location (QCL) relationship (not quasi-co-located). Reception of the multi-PDSCHs may be interpreted as simultaneous reception of the PDSCHs that are not of a certain QCL type (for example, QCL type D).

In URLLC for the multi-TRPs, support of PDSCH (transport block (TB) or codeword (CW)) repetition across the multi-TRPs has been under study. Support of repetition schemes (URLLC scheme, for example, schemes 1, 2a, 2b, 3, and 4) across the multi-TRPs in the frequency domain, the layer (space) domain, or the time domain has been under study.

In scheme 1, the multi-PDSCHs from the multi-TRPs are multiplexed by space division multiplexing (SDM). In schemes 2a and 2b, the PDSCH from the multi-TRPs is multiplexed by frequency division multiplexing (FDM). In scheme 2a, the redundancy versions (RV) are the same for the multi-TRPs. In scheme 2b, the RVs may be the same or may be different for the multi-TRPs. In schemes 3 and 4, the multi-PDSCHs from the multi-TRPs are multiplexed by time division multiplexing (TDM). In scheme 3, the multi-PDSCHs from the multi-TRPs are transmitted in one slot. In scheme 4, the multi-PDSCHs from the multi-TRPs are transmitted in different slots.

According to the multi-TRP scenario as described above, more flexible transmission control using channels with satisfactory quality can be performed.

### <Time Domain Resource Allocation>

In existing systems (for example, Rel. 15), resource allocation information of a physical shared channel (at least one of the PDSCH and the PUSCH) in the time domain is included in downlink control information (DCI). A network (for example, a base station) notifies the UE of at least one of information (for example, a time offset KO) related to an allocation slot of a physical shared channel scheduled by the DCI, a start symbol (S), and a length (L) by using a certain field (for example, a TDRA field) included in the DCI.

Each piece of bit information (or code point) notified by the TDRA field may be associated with a time domain resource allocation candidate (or entry) different from each other. For example, a table (for example, a TDRA table) in which each piece of bit information and the time domain resource allocation candidate (K0, S, L) are associated may be defined.

### [PDSCH]

The size (number of bits) of the TDRA field in the DCI (DL assignment, for example, DCI format 1_0 or 1_1) used for scheduling of the PDSCH may be fixed, or may be variable.

For example, the size of the TDRA field in DCI format 1_0 may be fixed to a certain number of bits (for example, 4 bits). In contrast, the size of the TDRA field in DCI format 1_1 may be the number of bits (for example, 0 to 4 bits) that changes depending on a certain parameter.

The certain parameter used for determination of the size of the TDRA field may be, for example, the number of entries in a list (PDSCH time domain allocation list) of time domain allocation for the PDSCH (or downlink data).

For example, the PDSCH time domain allocation list may be, for example, an RRC control element “pdsch-TimeDomainAllocationList” or “PDSCH-TimeDomainResourceAllocationList”.

The PDSCH time domain allocation list may be used for configuration of a time domain relationship between the PDCCH and the PDSCH. Each entry in the PDSCH time domain allocation list may be referred to as allocation information (PDSCH time domain allocation information) of time domain resources for the PDSCH or the like, and may be, for example, an RRC control element “PDSCH-TimeDomainResourceAllocation”.

The PDSCH time domain allocation list may be included in a PDSCH parameter (for example, an RRC control element “pdsch-ConfigCommon”) specific to a cell, or may be included in a parameter (for example, an RRC control element “pdsch-Config”) specific to a UE (specific to a UE applied to a specific BWP). In this manner, the PDSCH time domain allocation list may be specific to a cell, or may be specific to a UE.

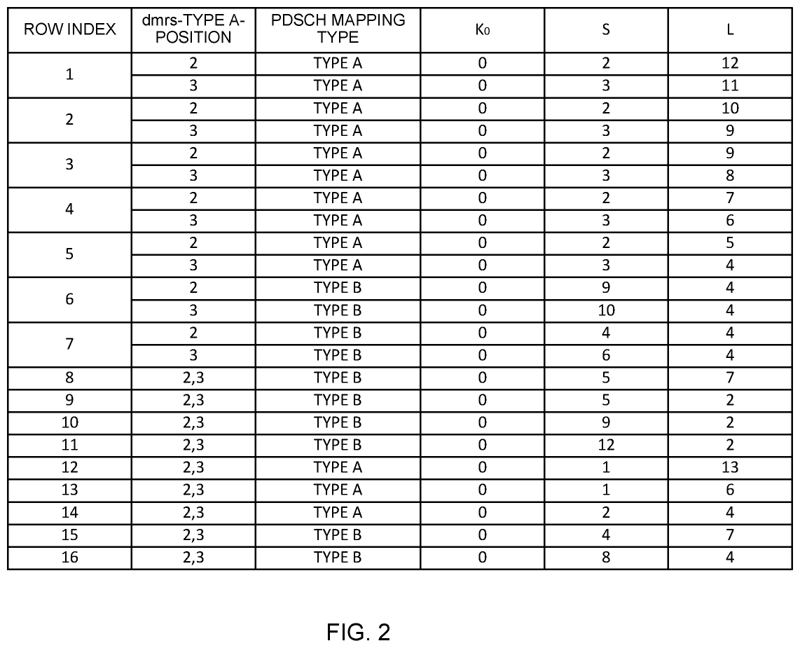

FIG. 2 is a diagram to show an example of the PDSCH time domain allocation list. As shown in FIG. 2, each piece of PDSCH time domain allocation information in the PDSCH time domain allocation list may include at least one of information (also referred to as offset information, KO information, or the like) indicating the time offset KO (also referred to as k0, K₀, or the like) between DCI and the PDSCH scheduled by the DCI, information (mapping type information) indicating a mapping type of the PDSCH, and the start symbol S and the time length L of the PDSCH. A combination of the start symbol S and the time length L of the PDSCH may be referred to as a Start and Length Indicator (SLIV).

Alternatively, the certain parameter used for determination of the size of the TDRA field may be the number of entries of a default table (for example, default PDSCH time domain allocation A) for time domain allocation for the PDSCH or the downlink data. The default table may be defined in a specification in advance. In each row of the default table, at least one of a row index, information indicating a position of a DMRS, the mapping type information, the K0 information, information indicating the start symbol S of the PDSCH, and information indicating the number L of symbols allocated to the PDSCH may be associated with one another.

The UE may determine the row index (entry number or entry index) of a certain table, based on a value of the TDRA field in the DCI (for example, DCI format 1_0 or 1_1). The certain table may be a table based on the PDSCH time domain allocation list, or may be the default table.

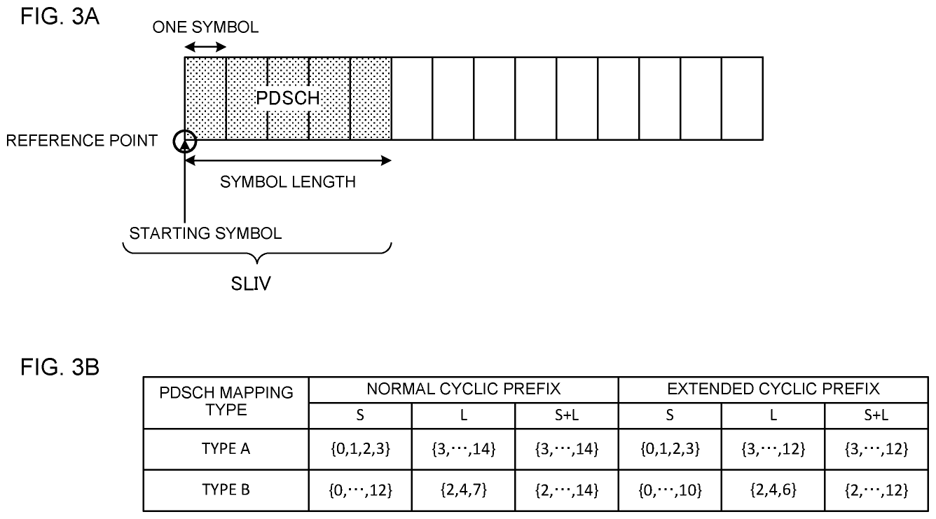

The UE may determine the time domain resources (for example, a certain number of symbols) allocated to the PDSCH in a certain slot (one or a plurality of slots), based on at least one of the KO information, the mapping type, the start symbol S, the symbol length L, and the SLIV defined in a row (or an entry) corresponding to the row index (see FIG. 3A). Note that the reference point of the start symbol S and the symbol length L is controlled based on the start position (initial symbol) of the slot. The start symbol S, the symbol length L, and the like may be defined depending on the mapping type of the PDSCH (see FIG. 3B).

As shown in FIG. 3A, in the existing systems (for example, Rel. 15), the reference point being a determination reference of time domain resource allocation (TDRA) is defined as a start point of a slot being a slot boundary. The UE determines allocation of a shared channel with the start point of a slot to which the physical shared channel is allocated being a reference regarding the resource allocation information (for example, the SLIV) specified by the TDRA field. Note that the reference point may be determined based not only on a slot boundary but on a control resource set as well. Note that the reference point may be referred to as a point of reference or a point as reference.

Note that the K0 information may indicate the time offset K0 between the DCI and the PDSCH scheduled by the DCI with the use of the number of slots. The UE may determine the slot for receiving the PDSCH with the time offset K0. For example, when the UE receives the DCI for scheduling the PDSCH in slot ∩n, the UE may determine the number n of the slot, and the slot for receiving the PDSCH (that is allocated to the PDSCH) based on at least one of a subcarrier spacing μ_{PDSCH} for the PDSCH, a subcarrier spacing μ_{PDCCH} for the PDCCH, and the time offset K0.

### [PUSCH]

The size (number of bits) of the TDRA field in the DCI (UL grant, for example, DCI format 0_0 or 0_1) used for scheduling of the PUSCH may be fixed, or may be variable.

For example, the size of the TDRA field in DCI format 0_0 may be fixed to a certain number of bits (for example, 4 bits). In contrast, the size of the TDRA field in DCI format 0_1 may be the number of bits (for example, 0 to 4 bits) that changes depending on a certain parameter.

The certain parameter used for determination of the size of the TDRA field may be, for example, the number of entries in a list (PUSCH time domain allocation list) of time domain allocation for the PUSCH (or uplink data).

For example, the PUSCH time domain allocation list may be, for example, an RRC control element “pusch-TimeDomainAllocationList” or “PUSCH-TimeDomainResourceAllocationList”. Each entry in the PUSCH time domain allocation list may be referred to as allocation information (PUSCH time domain allocation information) of time domain resources for the PUSCH or the like, and may be, for example, an RRC control element “PUSCH-TimeDomainResourceAllocation”.

The PUSCH time domain allocation list may be included in a PUSCH parameter (for example, an RRC control element “pusch-ConfigCommon”) specific to a cell, or may be included in a parameter (for example, an RRC control element “pusch-Config”) specific to a UE (specific to a UE applied to a specific bandwidth part (BWP)). In this manner, the PUSCH time domain allocation list may be specific to a cell, or may be specific to a UE.

Each piece of PUSCH time domain allocation information in the PUSCH time domain allocation list may include at least one of information (offset information, K2 information) indicating time offset K2 (also referred to as k2, K₂, or the like) between DCI and the PUSCH scheduled by the DCI, information (mapping type information) indicating a mapping type of the PUSCH, and an index (Start and Length Indicator (SLIV)) giving a combination of the start symbol and the time length of the PUSCH.

Alternatively, the certain parameter used for determination of the size of the TDRA field may be the number of entries of a default table (for example, default PUSCH time domain allocation A) for time domain allocation for the PUSCH or the uplink data. The default table may be defined in a specification in advance. In each row of the default table, at least one of a row index, the mapping type information, the K2 information, information indicating the start symbol S of the PUSCH, and information indicating the number L of symbols allocated to the PUSCH may be associated with one another.

The UE may determine the row index (entry number or entry index) of a certain table, based on a value of the TDRA field in the DCI (for example, DCI format 0_0 or 0_1). The certain table may be a table based on the PUSCH time domain allocation list, or may be the default table.

The UE may determine the time domain resources (for example, a certain number of symbols) allocated to the PUSCH in a certain slot (one or a plurality of slots), based on at least one of the K2 information, the SLIV, the start symbol S, and the time length L defined in a row (or an entry) corresponding to the row index.

Note that the K2 information may indicate the time offset K2 between the DCI and the PUSCH scheduled by the DCI with the use of the number of slots. The UE may determine the slot for transmitting the PUSCH with the time offset K2. For example, when the UE receives the DCI for scheduling the PUSCH in slot #n, the UE may determine the slot for transmitting the PUSCH (the slot that is allocated to the PUSCH), based on at least one of the number n of the slot, a subcarrier spacing μ_{PUSCH} for the PUSCH, a subcarrier spacing μ_{PDCCH} for the PDCCH, and the time offset K2.

Incidentally, in existing radio communication systems (for example, Rel. 15), the number of TDRA allocation candidates (or entries) notified by higher layer signaling is 16. In other words, the number of candidates (or entries) configured for the TDRA table by higher layer signaling is limited to 16 or 16 rows.

Thus, in the existing radio communication systems (for example, Rel. 15), the base station notifies the UE of a specific candidate (or entry) by using 4 bits in the TDRA field included in the DCI.

In contrast, for future radio communication systems (for example, Rel. 16), a scheme in which a repetition factor (or the number of times of repetition transmission) of a shared channel is also dynamically indicated for the UE by using the DCI has been under study. For example, information related to the repetition factor may be notified to the UE by using the TDRA field included in the DCI.

In this manner, when a combination (or a set) of time domain resource allocation and the repetition factor is notified by using the DCI, the number of candidates (or the number of entries) that can be configured for the UE is desirably large from the aspect of flexibly configuring a transmission condition such as the resource allocation and the repetition factor. For example, when scheduling a shared channel by using a single piece of DCI in the multi-TRPs (for example, scheme 4 or the like), allocation of the shared channel can be flexibly controlled by selecting the transmission condition out of a larger number of candidates.

Accordingly, in order to flexibly configure the transmission condition, it is assumed that the number of TDRA allocation candidates (or entries) or the size of the TDRA table is changed (for example, increased).

However, there is an issue in configuration of the TDRA allocation candidates or how to perform control when a specific candidate is notified to the UE in such a case. When the configuration of the TDRA allocation candidates or notification to the UE is not appropriately performed, allocation of a physical shared channel in the time domain is not appropriately performed, and communication quality may thus deteriorate.

The inventors of the present invention focused on the number of TDRA allocation candidates (or entries) being changed in some cases in NR, studied the configuration of the TDRA allocation candidate or the method in which the UE receives a specific candidate in such a case, and came up with the idea of one aspect of the present invention.

Embodiments according to the present disclosure will be described in detail below with reference to the drawings. Respective aspects may each be employed individually, or may be employed in combination. In the following aspects, description is given by taking an example of a downlink shared channel (PDSCH). However, the present disclosure can be similarly applied to an uplink shared channel (PUSCH) as well. In the following description, DCI, a PDCCH, and a control resource set may be interchangeably interpreted as each other.

### First Aspect

In a first aspect, an example of notification control of the number of specific candidates when the number of candidates or the number of entries of time domain resource allocation (TDRA) configured for the UE is variable will be described. Specifically, a case in which the size (for example, the number of bits) of the TDRA field in the DCI is determined based on information (for example, the number of TDRA candidates configured) notified by higher layer signaling will be described.

When the number of candidates of TDRA is variable, the number of TDRA candidates configured for the UE may be different in a first period and a second period. The size of the TDRA table may be determined depending on the number of rows of the TDRA table (for example, the number of candidates configured).

The network (for example, the base station) may notify the UE of the candidates of TDRA or configure the candidates of TDRA for the UE by using higher layer signaling. It is only necessary that each TDRA candidate at least include a combination (SLIV) of the start symbol S and the time length L of a shared channel. Each TDRA candidate may include information related to the repetition factor of the shared channel.

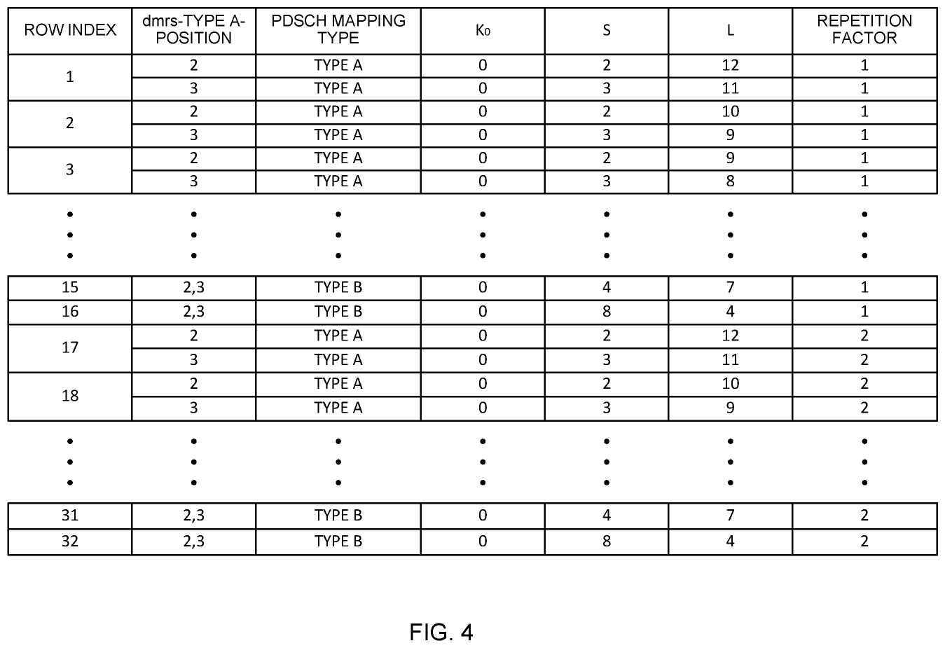

The TDRA candidates notified from the base station may be configured for the TDRA table (see FIG. 4). The TDRA table shown in FIG. 4 shows a case in which a position of a dmrs type, a PDSCH mapping type, a slot offset K0, the start symbol S, the time length L, and the repetition factor K are included in each TDRA candidate (or entry). However, contents configured for the TDRA table are not limited to these. For example, a part of the items above (for example, the PDSCH mapping type or the like) need not be defined, and another item may be defined.

The table shown in FIG. 4 shows a case in which the number of candidates (for example, rows #1 to #16) corresponding to a first repetition factor (for example, repetition factor=1) and the number of candidates (for example, rows #17 to 32) corresponding to a second repetition factor (for example, repetition factor=2) are the same. However, this is not restrictive. The number of candidates corresponding to different repetition factors may be configured to be different from each other.

When the base station performs scheduling of a shared channel, the base station may specify specific TDRA candidates for the UE by using the TDRA field in the DCI used for scheduling of the shared channel. In this case, the base station may determine the size (for example, the number of bits) of the TDRA field depending on the number of TDRA candidates notified to or configured for the UE.

The UE may determine the size of the TDRA field in the DCI, based on the number of candidates of TDRA configured from the base station or the number of entries (for example, the number of rows) configured for the TDRA table.

For example, when 16 TDRA candidates are configured from the base station (or when the number of rows is 16), the UE may assume that the TDRA field size of the DCI is 4 bits. When 64 TDRA candidates are configured from the base station (or when the number of rows is 64), it may be assumed that the TDRA field size of the DCI is 6 bits.

In this manner, the UE determines the size of the TDRA field in the DCI, based on the number of candidates of TDRA (or the number of rows of the TDRA table) configured from the base station. With this, even when the number of TDRA candidates is configured (configurable) to be changeable, notification of specific TDRA candidates using DCI can be appropriately performed.

### Second Aspect

In a second aspect, another example of notification control of the number of specific candidates when the number of candidates or the number of entries of time domain resource allocation (TDRA) configured for the UE is variable will be described. Specifically, a case in which the size (for example, the number of bits) of the TDRA field in the DCI is determined based on information (for example, the repetition factor or the number of times of repetition transmission) notified by higher layer signaling will be described.

The network (for example, the base station) may notify or configure the UE of information related to the repetition factor of a shared channel (for example, one or more repetition factor candidates) by using higher layer signaling (for example, URLLCRepNum). The repetition factor candidate(s) may be configured for the UE (for example, configured for the TDRA table) by being combined with the start symbol S and the time length L (SLIV) of the shared channel, or may be configured for the UE separately from the SLIV.

The base station may configure a part or all of certain repetition factor candidates for the UE. The certain repetition factor candidates may be {1, 2, 4, 8} or {2, 4, 8, 16}. As a matter of course, the number of repetition factor candidates is not limited to four types, and may be five or more types. The shared channel corresponding to the repetition factor configured from the base station (for example, configured for the TDRA table) using higher layer signaling may correspond to a certain traffic type.

The base station may change the number of TDRA candidates configured for the UE depending on the number of repetition factor candidates configured for the UE. Note that the number of TDRA candidates may be interchangeably interpreted as the number of rows of the TDRA table or the size of the TDRA table. For example, the number of TDRA candidates when the number of repetition factor candidates configured for the UE is X1 may be smaller than the number of TDRA candidates when the number of repetition factor candidates is X2 (X1<X2).

The UE may determine at least one of the number of TDRA candidates and the size of the TDRA field in the DCI, based on the number of repetition factor candidates configured from the base station.

For example, the size of the TDRA table may be determined based on a certain number (M) and the number (X) of repetition factor candidates. M may be a certain value (for example, the number (16) of entries of the TDRA table of existing systems). It is only necessary that X be a value corresponding to the number of candidates (or the type) of the repetition factor that can be configured for the UE, and when four repetition factors (for example, {1, 2, 4, 8} or {2, 4, 8, 16}) can be configured, X may be {1, 2, 3, 4}.

For example, when the number of types of the repetition factors configured for the UE is two (for example, {1, 2}), the TDRA table size may be M×2. When M is a certain value (for example, 16), the UE may determine that the TDRA table size is 32, or determine that the TDRA field size of the DCI is 5 bits.

When the number of types of the repetition factors configured for the UE is four (for example, {1, 2, 4, 8} or {2, 4, 8, 16}), the TDRA table size may be M×4. When M is a certain value (for example, 16), the UE may determine that the TDRA table size is 64, or determine that the TDRA field size of the DCI is 6 bits.

In this manner, by controlling the TDRA field size or the TDRA candidates based on the number of repetition factor candidates (or the types of the repetition factors) configured for the UE, overhead of DCI can be prevented from increasing when the number of repetition factor candidates is small.

Note that the description herein illustrates a case in which the TDRA field size or the TDRA field size of the DCI is controlled based on the number of repetition factor candidates configured for the UE. However, this is not restrictive. The TDRA field size or the TDRA field size of the DCI may be controlled based on a value of the repetition factor candidates (the number of repetitions) configured for the UE.

When the repetition factor candidates are configured by being combined with the SLIV or the like (for example, configured for the TDRA table), it is only necessary that the UE determine the SLIV and the repetition factor based on the bit information (or code point) of the TDRA field in the DCI. When a plurality of repetition factor candidates (for example, 1, 2, and the like) are configured, a value of the SLIV configured to correspond to each repetition factor may be the same, or may be configured to be different. By permitting such different configuration, resource allocation of the shared channel can be flexibly configured depending on the number of times of repetition.

Note that the repetition factor candidates may be configured without being combined with the SLIV or the like (for example, not configured for the TDRA table). In this case, a certain field for specifying a repetition factor to be applied out of the repetition factor candidates configured for the UE may be configured for the DCI. The size of the certain field may be variably controlled based on the number of repetition factors configured for the UE.

### Third Aspect

In a third aspect, an example of UE operation when the repetition factor configured for the UE is a certain value will be described. The configuration given below may be applied when, for example, the multi-TRPs (scheme 4) or the like is configured.

The following description assumes a case in which the repetition factor configured from the base station by higher layer signaling is a certain value (for example, URLLCRepNum=1). In such a case, the UE may determine allocation of a shared channel, based on at least one of the following options 1 to 3. Note that the value of the repetition factor configured for the UE is not limited to 1.

### <Option 1>

The UE may use the TDRA table supported in existing systems (for example, Rel. 15). A certain number (16) of TDRA candidates or entries are configured for the TDRA table, and thus the UE may perform reception processing by assuming that the size of the TDRA field in the DCI is 4 bits. The UE may determine the repetition factor, based on information notified by higher layer signaling.

### <Option 2>

The UE may use a table (hereinafter also referred to as a new table) that is different from the TDRA table supported in the existing systems (for example, Rel. 15). The new table may be a table including items at least one which is different from the items included in the TDRA table of the existing systems. Alternatively, the new table may be a table that has the same items as those of the TDRA table of the existing systems but their configured values are different from those in the TDRA table.

Note that the size (or the number of TDRA candidates configured) of the new table may be a specific size (for example, the same size as that of the table supported in the existing systems). In this case, the UE may perform reception processing by assuming that the size of the TDRA field in the DCI is 4 bits. The UE may determine the repetition factor, based on information notified by at least one of higher layer signaling and DCI.

When 1 is configured as the repetition factor, the UE may determine whether it is single TRP operation or multi-TRP operation, based on certain information.

For example, when a certain scheme (for example, scheme 4) of repetition transmissions using the multi-TRPs is configured, the multi-PDSCHs from the multi-TRPs are transmitted in different slots. In other words, in scheme 4, 2 or more needs to be configured as the repetition factor. In such a case, when 1 is configured as the repetition factor, the UE may determine it is an error case, or may determine a transmission mode (mode of TRP operation), based on certain information.

For example, when the number of TCI states notified by DCI is 1, or when the code point of the TCI having the minimum index (lowest TCI codepoint) is 1, the UE may assume the single TRP operation.

In contrast, when the number of TCI states notified by DCI is 2, or when the code point of the TCI having the minimum index (lowest TCI codepoint) is 2, the UE may assume the multi-TRP operation. The multi-TRP operation may be the multi-TRP operation of scheme 1 in which the PDSCHs transmitted from respective TRPs are multiplexed by space division multiplexing (SDM (for example, SDM 1a)).

In this manner, by determining the mode of TRP operation based on certain information, communication can be appropriately performed even when 1 is configured as the repetition factor when communication using the multi-TRPs is performed.

### <Option 3>

The UE may use a table (hereinafter also referred to as a new table) that is different from the TDRA table supported in the existing systems (for example, Rel. 15). The new table may have a size different from the size (or the number of TDRA candidates configured) of the TDRA table of existing systems.

For example, the number of rows (or the number of TDRA candidates configured) x of the new table may be configured by higher layer signaling. In this case, the UE may determine the TDRA field size of the DCI, based on the number of rows of the new table. For example, the UE may perform reception processing by assuming that the TDRA field size is log2 (x) bits.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

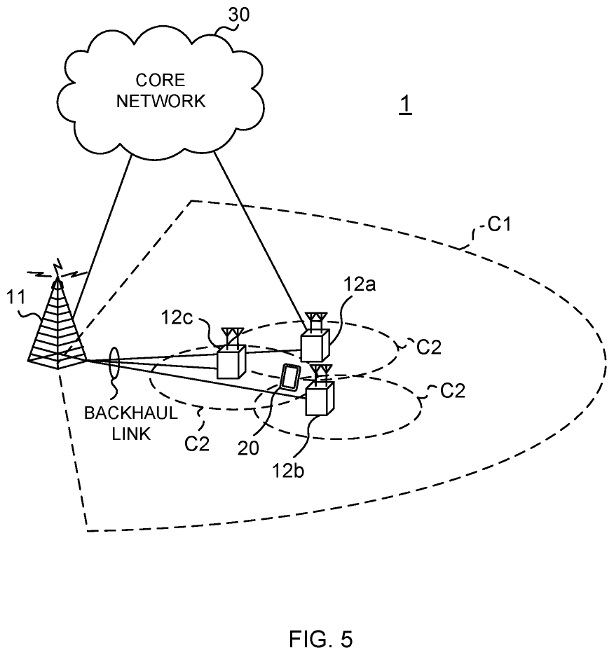

FIG. 5 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### Base Station

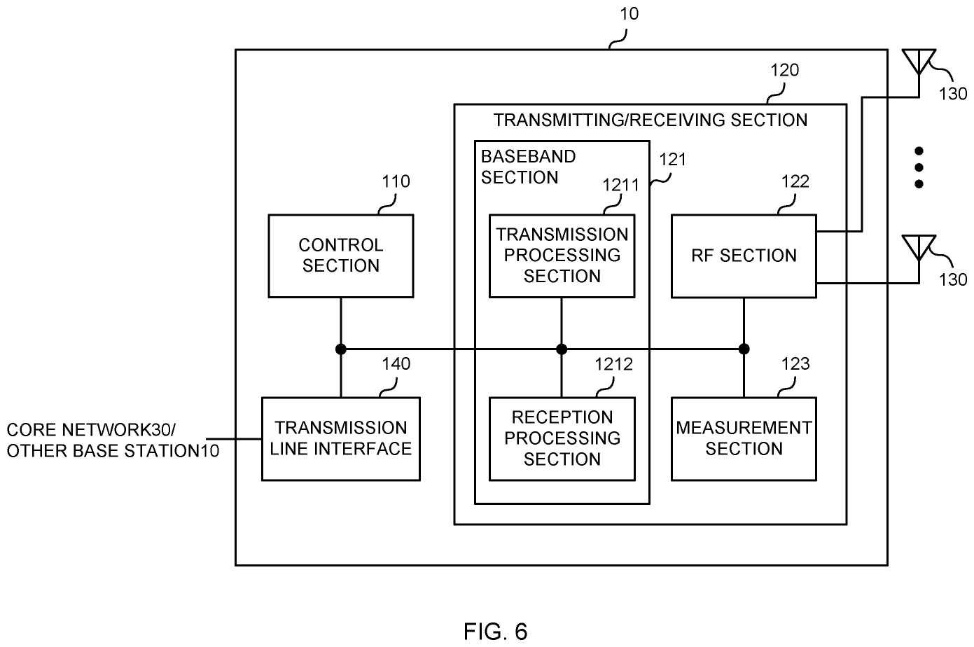

FIG. 6 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 transmits downlink control information including a time domain resource allocation (TDRA) field. The transmitting/receiving section 120 may transmit information related to the number of time domain resource allocation candidates. The information related to the number of time domain resource allocation candidates may be not only information indicating the number of candidates itself but also information giving notification of candidates to be configured.

The transmitting/receiving section 120 may transmit information related to a repetition factor. The information related to the repetition factor may be repetition factor candidates configured for the UE, or may be the number of repetition factors configured for the UE.

The control section 110 may control the time domain resource allocation candidates (or the number of candidates) configured for the UE and the repetition factor candidates (or the number of candidates).

### User Terminal

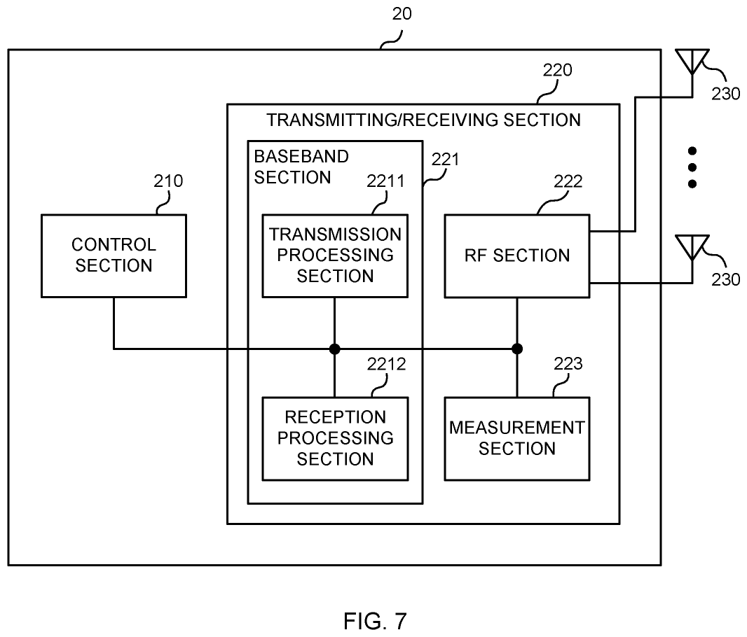

FIG. 7 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 receives downlink control information including a time domain resource allocation (TDRA) field. The transmitting/receiving section 220 may receive information related to the number of time domain resource allocation candidates. The information related to the number of time domain resource allocation candidates may be not only information indicating the number of candidates itself but also information giving notification of candidates to be configured.

The transmitting/receiving section 220 may receive information related to a repetition factor. The information related to the repetition factor may be repetition factor candidates configured for the UE, or may be the number of repetition factors configured for the UE.

The control section 210 may determine a size of the TDRA field, based on information notified by higher layer signaling.

The information notified by the higher layer signaling may be information related to number of candidates of time domain resource allocation. Alternatively, the information notified by the higher layer signaling may be information related to a repetition factor (for example, number of repetition factor candidates).

When 1 is notified as the repetition factor, the control section 210 may determine that the TDRA field is a specific size.

The control section 210 may determine a start symbol and a period of a shared channel and number of times of repetition transmission, based on bit information specified by the TDRA field.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

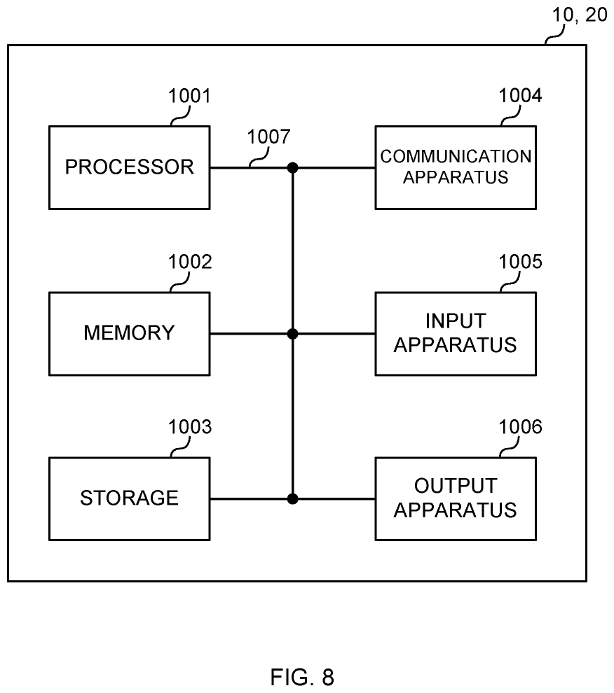

For example, a base station, a user terminal, and so on according to one embodiment of the present disclosure may function as a computer that executes the processes of the radio communication method of the present disclosure. FIG. 8 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### Variations

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 MS.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a mobile body or a mobile body itself, and so on. The mobile body may be a vehicle (for example, a car, an airplane, and the like), may be a mobile body which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1-6. (canceled)

7. A terminal comprising:
a receiver that receives first information regarding one or more time domain resource allocation candidates notified by higher layer signaling and second information regarding a certain time domain resource allocation candidate indicated by a time domain resource allocation field included in downlink control information; and
a processor that determines, based on a number of the one or more time domain resource allocation candidates, a size of the time domain resource allocation field,
wherein each of the time domain resource allocation candidates has information regarding a start symbol and length (SLIV) of a downlink shared channel and a number of repetitions, and a SLIV value corresponding to each number of repetitions can be configured separately.

8. The terminal according to claim 7, wherein a number of the time domain resource allocation candidates corresponding to different numbers of repetitions can be configured separately.

9. A radio communication method for a terminal, comprising:
receiving first information regarding one or more time domain resource allocation candidates notified by higher layer signaling and second information regarding a certain time domain resource allocation candidate indicated by a time domain resource allocation field included in downlink control information; and
determining, based on a number of the one or more time domain resource allocation candidates, a size of the time domain resource allocation field,
wherein each of the time domain resource allocation candidates has information regarding a start symbol and length (SLIV) of a downlink shared channel and a number of repetitions, and a SLIV value corresponding to each number of repetition can be configured separately.

10. A base station comprising:
a transmitter that transmits first information regarding one or more time domain resource allocation candidates notified by higher layer signaling and second information regarding a certain time domain resource allocation candidate indicated by a time domain resource allocation field included in downlink control information; and
a processor that determines, based on a number of the one or more time domain resource allocation candidates, a size of the time domain resource allocation field,
wherein each of the time domain resource allocation candidates has information regarding a start symbol and length (SLIV) of a downlink shared channel and a number of repetitions, and a SLIV value corresponding to each number of repetitions can be configured separately.

11. A system comprising a terminal and a base station, wherein
the terminal comprises:
a receiver that receives first information regarding one or more time domain resource allocation candidates notified by higher layer signaling and second information regarding a certain time domain resource allocation candidate indicated by a time domain resource allocation field included in downlink control information; and
a processor that determines, based on a number of the one or more time domain resource allocation candidates, a size of the time domain resource allocation field, and
the base station comprises:
a transmitter that transmits first information regarding one or more time domain resource allocation candidates notified by higher layer signaling and second information regarding a certain time domain resource allocation candidate indicated by a time domain resource allocation field included in downlink control information; and
a processor that determines, based on a number of the one or more time domain resource allocation candidates, a size of the time domain resource allocation field,
wherein each of the time domain resource allocation candidates has information regarding a start symbol and length (SLIV) of a downlink shared channel and a number of repetitions, and a SLIV value corresponding to each number of repetitions can be configured separately.
